(19) United States
(12) Patent Application Publication
(10) Pub. No.: US 2018/0293146 A1
(43) Pub. Date: Oct. 11, 2018

(54) INFORMATION PROCESSING APPARATUS, INFORMATION PROCESSING METHOD AND INFORMATION PROCESSING SYSTEM

(71) Applicant: FUJITSU LIMITED, Kawasaki-shi (JP)

(72) Inventor: Tatsuhiko USHIKI, Kawasaki (JP)

(73) Assignee: FUJITSU LIMITED, Kawasaki-shi (JP)

(21) Appl. No.: 15/921,743

(22) Filed: Mar. 15, 2018

(30) Foreign Application Priority Data
Apr. 11, 2017 (JP) 2017-078073

(51) Int. Cl. G06F 11/30; G06F 11/34

(52) U.S. Cl. CPC G06F 11/3006; G06F 11/3476; G06F 11/3072

(57) ABSTRACT

An information processing apparatus is included in a system including a monitoring device and first devices that transmit data to the monitoring device in accordance with a schedule, the information processing apparatus is included in the first devices and includes a memory, and a processor coupled to the memory and the processor is configured to select a target device for which a schedule is to be set from among the first devices based on a priority of each of the first devices, the priority being acquired from other ones of the first devices, and when, in the schedule, an unset period in which a transmission period for data transmission to the monitoring device is not set for one or more first devices other than the target device among the first devices is present, set a start time for the data transmission by the target device within the unset period.

### CROSS-REFERENCE TO RELATED APPLICATION

This application is based upon and claims the benefit of priority of the prior Japanese Patent Application No. 2017-078073, filed on Apr. 11, 2017, the entire contents of which are incorporated herein by reference.

### FIELD

The embodiment discussed herein is related to an information processing apparatus, an information processing method, and an information processing system.

### BACKGROUND

For example, in an information processing system including a plurality of devices, a monitoring device, which is disposed in a support center and manages the entire system, remotely monitors the operation state, communication state, and the like of each of a plurality of devices in the system. In such remote monitoring, a device to be monitored (a monitored device) periodically connects to the monitoring device in the support center. The timing at which a monitored device periodically connects to the monitoring device is set in advance for every monitored device. During the periodic connection, the monitored device transmits, for example, data indicating the state of the monitored device to the monitoring device.

A related-art technique proposes that a period during which a user system connects to a maintenance center in a remote location be determined based on the operating time of the user system (for example, refer to Japanese Laid-open Patent Publication No. 2000-29743).

In addition, techniques in which a device that collects data calculates the usage of a collection target and creates a data collection schedule when the operation rate is low have been proposed as related-art techniques (for example, refer to Japanese Laid-open Patent Publication No. 2006-79488).

In addition, in a computer management method in which maintenance of a computer is performed via a network, a technique of determining a computer as the connection destination based on the order of priority for maintenance of computers has been proposed as a relate-art technique (for example, refer to Japanese Laid-open Patent Publication No. 2003-177945).

### SUMMARY

According to an aspect of the invention, an information processing apparatus included in an information processing system including a monitoring device and a plurality of first devices that transmit data to the monitoring device in accordance with a schedule, at least one information processing apparatus being included in the plurality of first devices, the information processing apparatus includes a memory, and a processor coupled to the memory and the processor is configured to select a target device for which a schedule is to be set from among the plurality of first devices based on a priority of each of the plurality of first devices, the priority being acquired from other ones of the plurality of first devices, and when, in the schedule, an unset period in which a transmission period for data transmission to the monitoring device is not set for one or more first devices other than the target device among the plurality of first devices is present, set a start time for the data transmission by the target device within the unset period.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an overall configuration of an information processing system in an embodiment;

FIG. 2 is a diagram illustrating an example of an information processing apparatus;

FIG. 3 is a diagram illustrating an example of an electronic device;

FIG. 4 is a diagram illustrating an example of priority information for various device types;

FIG. 5 is a diagram illustrating an example of priority information of monitored devices;

FIG. 6 is a diagram illustrating an example of information indicating transmission data sizes of monitored devices;

FIG. 7 is a diagram illustrating an example of specified time zones of periodic connection of monitored devices;

FIG. 8 is a diagram illustrating an example of transfer rates of a monitored device;

FIG. 9 is a diagram illustrating an example of total transfer rate information of monitored devices;

FIG. 10 illustrates an example of a periodic connection schedule;

FIG. 11 is a flowchart (1) illustrating an example of a process flow of an information processing apparatus;

FIG. 12 is a flowchart (2) illustrating an example of a process flow of an information processing apparatus;

FIG. 13 is a flowchart illustrating an example of a process flow of operation S105 in FIG. 11;

FIG. 14 is a flowchart illustrating an example of a process flow of operation S106 in FIG. 11;

FIG. 15 is a flowchart illustrating an example of a process flow of operation S108 in FIG. 11;

FIG. 16 is a flowchart illustrating an example of a process flow of operation S114 in FIG. 12;

FIG. 17 is a flowchart illustrating an example of a process flow of operation S116 in FIG. 12;

FIG. 18 is a flowchart illustrating an example of a process flow of operation S117 in FIG. 12; and

FIG. 19 is a diagram illustrating an example of a hardware configuration of an information processing apparatus and an electronic device.

### DESCRIPTION OF EMBODIMENT

In a system including a plurality of monitored devices, with an increasing number of monitored devices monitored by one monitoring device, there is an increasing possibility that overlapping occurs in a periodic connection schedule (data transmission schedule) according to which each of the monitored devices periodically connects to the monitoring device and transmits data. The overlapping in the data transmission schedule of the monitored devices increases the network load, possibly resulting in a delay in communication.

Accordingly, it is desirable to reduce overlapping in the data transmission schedule of the monitored devices. However, in cases where a data transmission schedule is set, the more monitored devices there are, the more difficult it is to appropriately set a data transmission schedule that avoids the overlapping mentioned above.

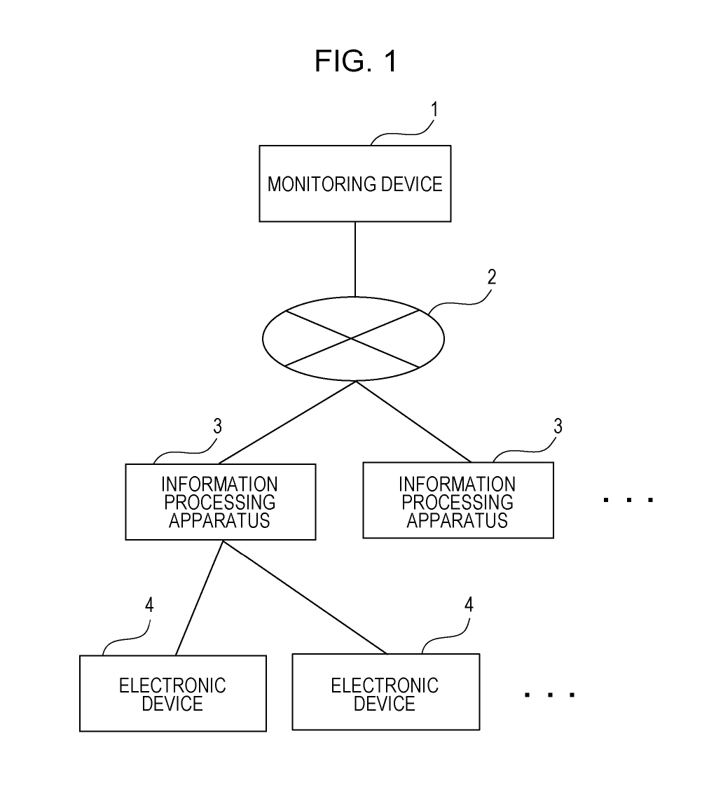

Hereinafter, an embodiment of a technique of appropriately setting a data transmission schedule of a plurality of monitored devices will be described with reference to the accompanying drawings. FIG. 1 illustrates an example of an overall configuration of an information processing system in an embodiment. The information processing system in the embodiment includes a monitoring device 1, a network 2, information processing apparatuses 3, and electronic devices 4. The information processing apparatuses 3 and the electronic devices 4 are devices to be monitored by the monitoring device 1. The information processing apparatuses 3 and the electronic devices 4 are sometimes referred to as monitored devices hereinafter. The monitored device is an example of a first device.

The monitoring device 1 accepts periodic connection from a monitored device and remotely monitors the operation state, communication state, and the like of the monitored device. The monitoring device 1 is, for example, a server installed in a support center. The monitoring device 1 is an example of a second device.

The network 2 is, for example, an Internet network. The network 2 may be, for example, a local area network (LAN).

The information processing apparatus 3 is coupled to the monitoring device 1 via the network 2, and communication is performed between the information processing apparatus 3 and the monitoring device 1. The information processing apparatus 3 is, for example, a server. In the example in FIG. 1, the information processing apparatus 3 and the electronic devices 4 are coupled to each other; however, no electronic device 4 is coupled to the information processing apparatus 3 in some cases.

The electronic device 4 is capable of communicating with the information processing apparatus 3 via a communication line such as a LAN. The electronic device 4 is, for example, storage or a communication device such as a switch. In the example illustrated in FIG. 1, the electronic device 4 is coupled to the information processing apparatus 3; however, during the periodic connection, the electronic device 4 may communicate with the monitoring device 1 via the network 2, not via the information processing apparatus 3.

The system in the embodiment includes a plurality of monitored devices. The monitored device is the information processing apparatus 3 in some cases and is the electronic device 4 coupled to the information processing device 3 of interest in other cases. At least one of the plurality of monitored devices is the information processing apparatus 3.

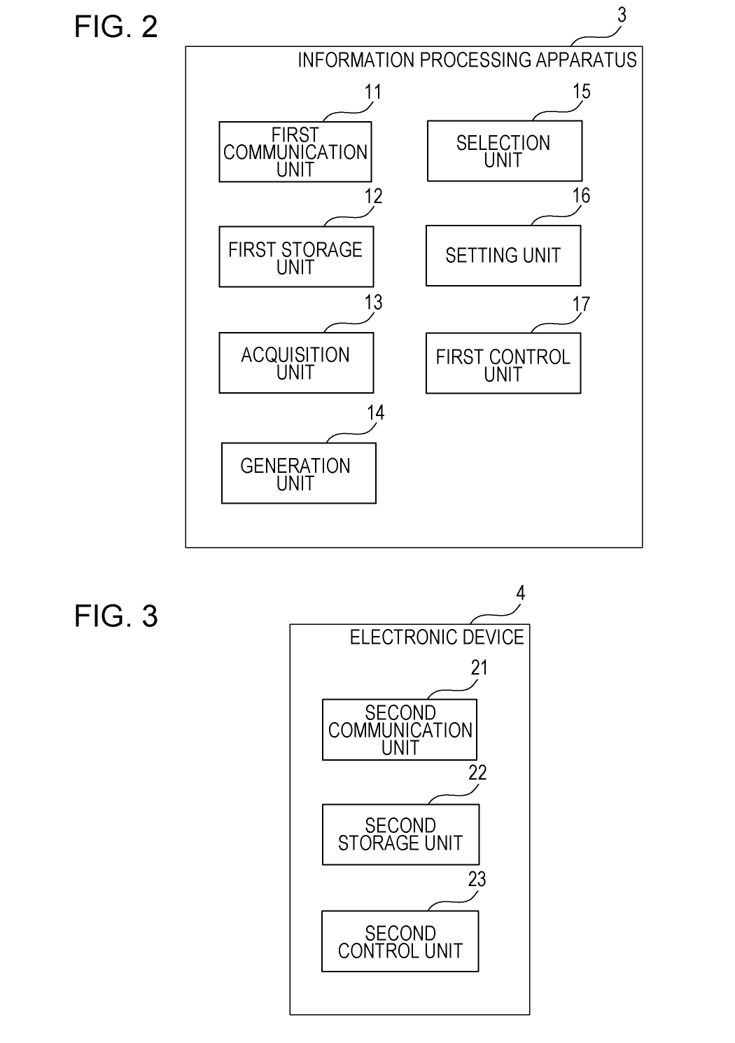

FIG. 2 is a diagram illustrating an example of the information processing apparatus 3. The information processing apparatus 3 includes a first communication unit 11, a first storage unit 12, an acquisition unit 13, a generation unit 14, a selection unit 15, a setting unit 16, and a first control unit 17.

The first communication unit 11 transmits and receives various types of information to and from the monitoring device 1, the other information processing apparatuses 3, and the electronic devices 4.

The first storage unit 12 stores therein various types of information about the plurality of monitored devices. The first storage unit 12 stores therein, for example, the priority information, transmission data sizes, specified time zones for periodic connection, transfer rates, and periodic connection schedules of monitored devices. The details of information stored in the first storage unit 12 will be described later.

The acquisition unit 13 acquires various types of information about the plurality of monitored devices from other monitored devices. The acquisition unit 13 acquires, for example, the priority information, transmission data sizes, specified time zones for periodic connection, and transfer rates of monitored devices.

The generation unit 14 calculates the average of acquired transfer rates of all the monitored devices so as to generate total transfer rate information indicating the values of the averages of transfer rates of all the monitored device.

The selection unit 15 selects a monitored device that serves as a target for which a periodic connection schedule is to be set (a target device) from among a plurality of monitored devices, based on priority information of the plurality of monitored devices acquired by the acquisition unit 13. The periodic connection schedule is a schedule regarding data transmission from a monitored device to the monitoring device 1 during a periodic connection therebetween and includes a data transmission start time and a data transmission period.

The selection unit 15 may preferentially select a monitored device in which the size of data is largest to be transmitted from among monitored devices having the same priority. When there is no time in which a schedule for the selected monitored device is able to be set, the selection unit 15 may select a monitored device in which the size of data is smallest to be transmitted from among monitored devices having the same priority.

When, in the periodic connection schedule, an unset period in which, for transmission periods of monitored devices other than the selected monitored device, any of the transmission periods is not set is present, the setting unit 16 sets a data transmission start time of the selected monitored device within this period.

The setting unit 16 may set a periodic connection schedule regarding data transmission of the selected monitored device based on a specific time zone of data transmission set for the selected monitored device.

The setting unit 16 divides the size of data scheduled to be transmitted of the setting target device by a transfer rate to calculate the time taken for transmission (transmission period). When, in the periodic connection schedule, a period in which the transmission periods of monitored devices other than the selected monitored device are not set and that is longer than or equal to the data transmission period of the selected monitored device is present, the setting unit 16 may set a data transmission period of the monitored device within this period.

When there is no time in which a schedule for the selected monitored device is able to be set, the setting unit 16 sets the data transmission start time of the selected monitored device in a time zone with the highest transfer rate between the plurality of monitored devices and the monitoring device 1.

The first control unit 17 performs various types of control over the information processing apparatuses 3. Upon arrival of a data transmission start time of the device (information processing apparatus 3) of the first communication unit 11, the first communication unit 11 transmits data indicating the state of this device to the monitoring device 1 and transmits an updated periodic connection schedule to the other monitored devices. The first communication unit 11 may transmit various types of information such as the priority, data size, specified time zone, and transfer rate of its device together with the updated periodic schedule to the other monitored devices.

FIG. 3 is a diagram illustrating an example of an electronic device. As illustrated in FIG. 3, the electronic device 4 includes a second communication unit 21, a second storage unit 22, and a second control unit 23.

The second communication unit 21 transmits and receives various types of information to and from the monitoring device 1, the information processing apparatuses 3, and other electronic devices 4. Upon arrival of a data transmission start time of the device of the second communication unit 21, this second communication unit 21 transmits data indicating the state of this device to the monitoring device 1. During periodic connection, the second communication unit 21 may transmit various types of information such as the priority, data size, specified time zone, and transfer rates of its device to the other monitored devices.

The second storage unit 22 stores therein various types of information regarding a plurality of monitored devices. The second storage unit 22 stores therein, for example, the priority information, transmission data sizes, specified time zones of periodic connection, transfer rates, and periodic connection schedule of monitored devices. Information stored in the second storage unit 12 will be described in more detail later. The second control unit 23 performs various types of control of the electronic devices 4.

Hereinafter, various types of information that are stored in the first storage unit 12 of the information processing apparatus 3 and the second storage unit 22 of the electronic device 4 will be described.

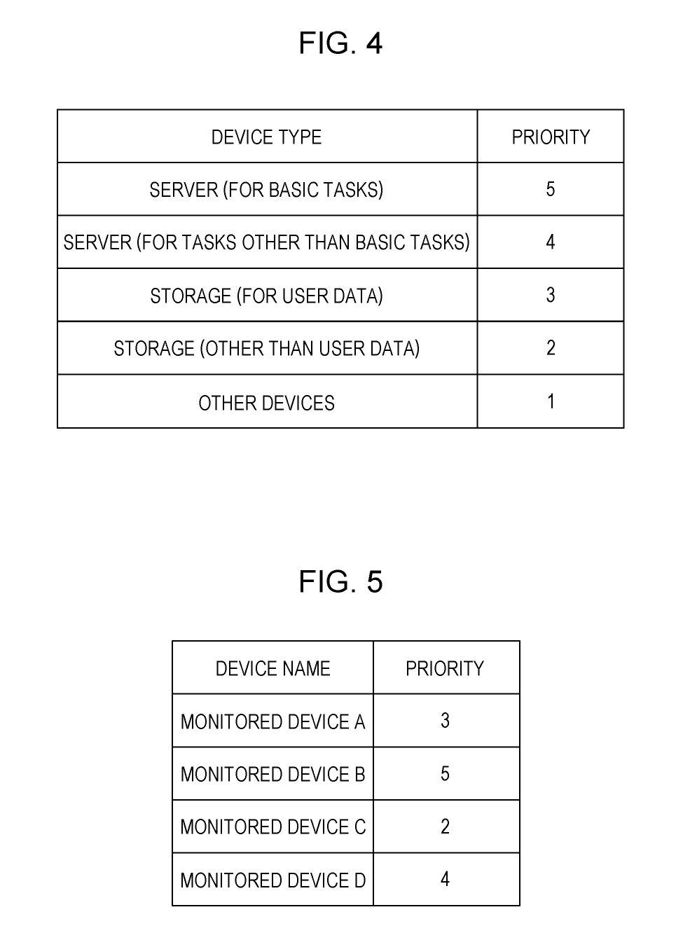

FIG. 4 is a diagram illustrating an example of priority information for various device types. In the priority information for device types as illustrated in FIG. 4, the device types of monitored devices and the priorities are associated with each other. For example, a high priority is assigned to a device that is to be preferentially recovered at the time of failure occurrence. Note that, in the embodiment, the larger the number denoting priority level, the higher the priority.

FIG. 5 is a diagram illustrating an example of priority information of monitored devices. In the priority information of monitored devices as illustrated in FIG. 5, the device names of monitored devices and the priorities are associated with each other. The priority information of monitored devices illustrated in FIG. 5 is set in advance based on the priority information for every device type illustrated in FIG. 4.

The acquisition unit 13 may acquire the priority information of monitored devices illustrated in FIG. 5 and may also determine the priorities of monitored devices based on the priority information for every device type illustrated in FIG. 4 and information indicating the types of monitored devices.

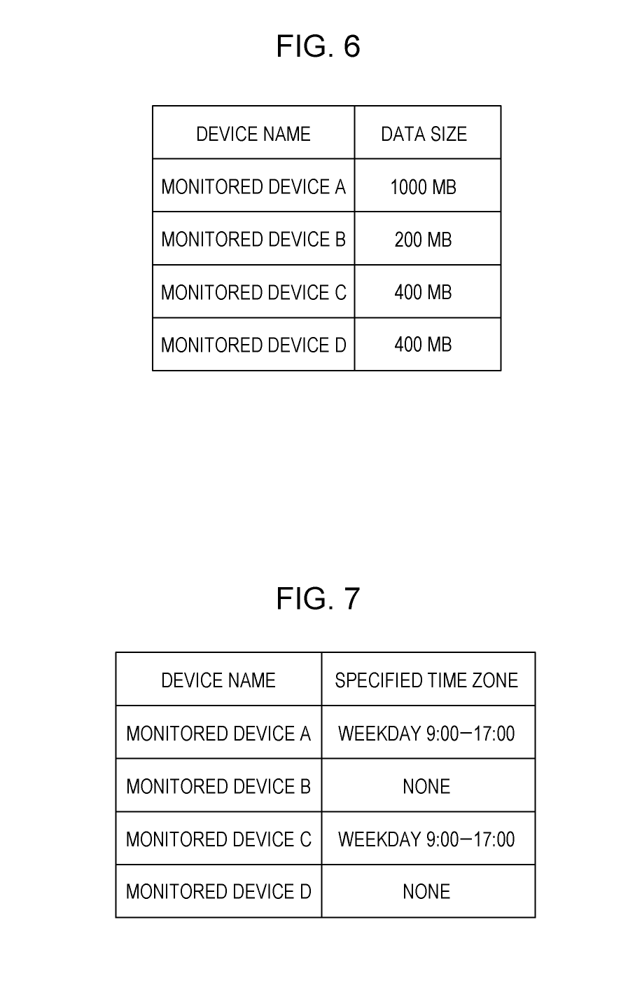

FIG. 6 is a diagram illustrating an example of information indicating the transmission data sizes of monitored devices. In the information indicating the transmission data sizes of monitored devices as illustrated in FIG. 6, the device names of monitored devices and the data sizes, which are the sizes of data to be transmitted by the monitored devices at the time of periodic connection, are associated with each other.

FIG. 7 is a diagram illustrating an example of specified time zones of periodic connection of monitored devices. As illustrated in FIG. 7, specified time zones in which periodic connection to the monitoring device 1 is accomplished are set for monitored devices in some cases. For example, when the monitoring device 1 detects the occurrence of a failure during periodic connection of a monitored device, maintenance is performed by the administrator. Accordingly, for example, the time zone in which it is possible for the administrator to perform maintenance is set as a specified time zone.

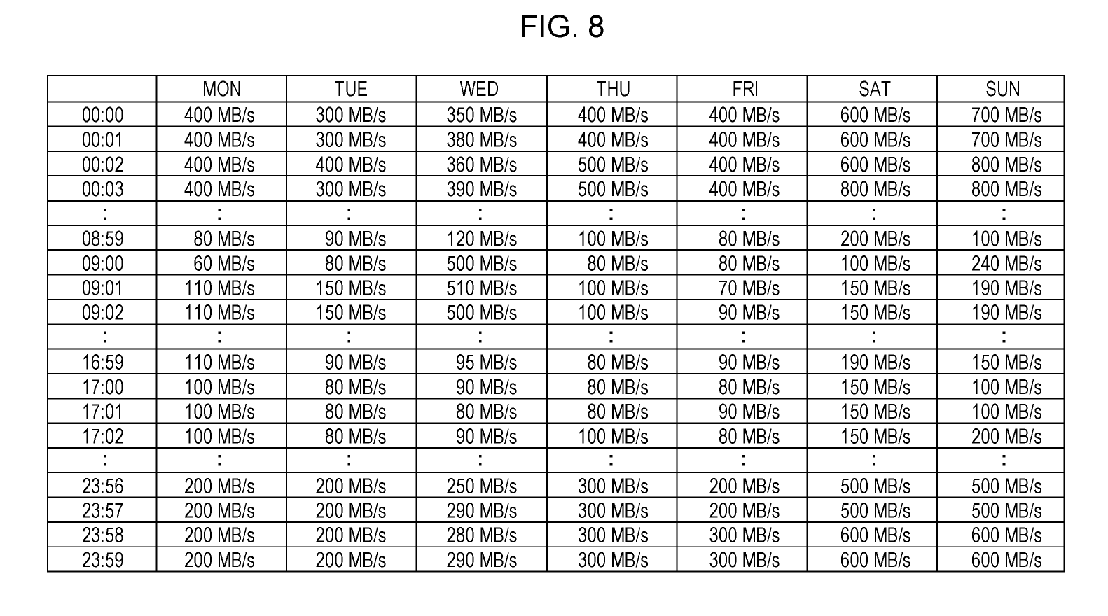

FIG. 8 is a table illustrating an example of transfer rates of a monitored device. The transfer rates illustrated in FIG. 8 represent the transfer rates between any monitored device and the monitoring device 1. The first storage unit 12 and the second storage unit 22 store therein tables in each of which transfer rates are recorded as illustrated in FIG. 8, the tables being given for the monitored devices, respectively.

Note that a monitored device does not necessarily have the experience of communication in all of the time zones. For a time zone without the experience of communication, for example, the average of transfer rates in the network 2 between the monitored device and the monitoring device 1 is used. In addition, in the example illustrated in FIG. 8, the transfer rate per minute is illustrated; however, the time unit for which the transfer rate is maintained is not limited to one minute.

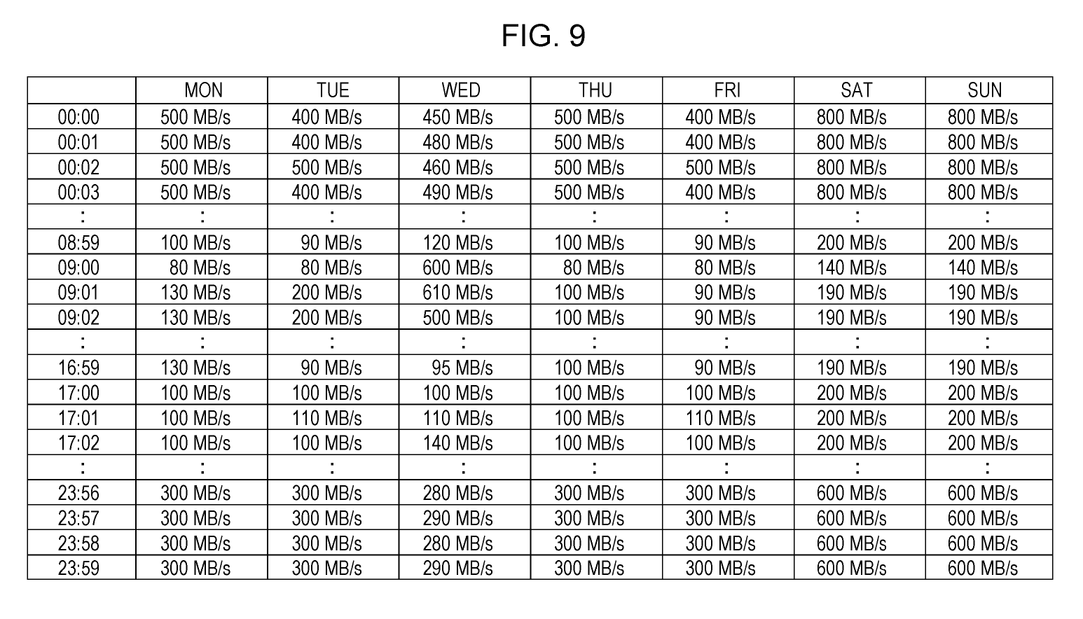

FIG. 9 is a diagram illustrating an example of total transfer rate information of monitored devices. The transfer rate illustrated in FIG. 9 indicates a value obtained by averaging the transfer rate between each monitored device and the monitoring device 1 (for example, in FIG. 8) for each time zone.

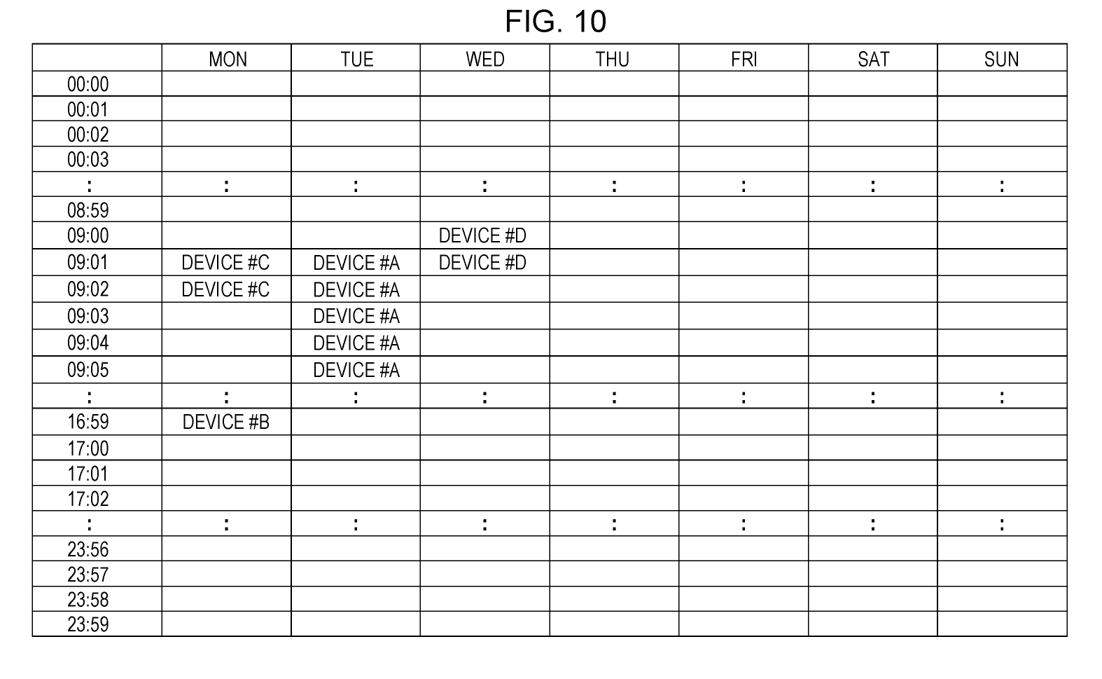

FIG. 10 is an example of a periodic connection schedule. As illustrated in FIG. 10, a periodic connection schedule indicates time zones for periodic connection of each monitored device. For example, in the example in FIG. 10, it is indicated that a monitored device C initiates periodic connection at 9:01 and terminates the periodic connection before 9:03.

As described above, the sizes of data transmitted during periodic connection differ for each monitored device, and the transfer rates differ for each time zone in which a monitored device transmits data. Thus, the time taken during periodic connection differs for each monitored device as illustrated in FIG. 10.

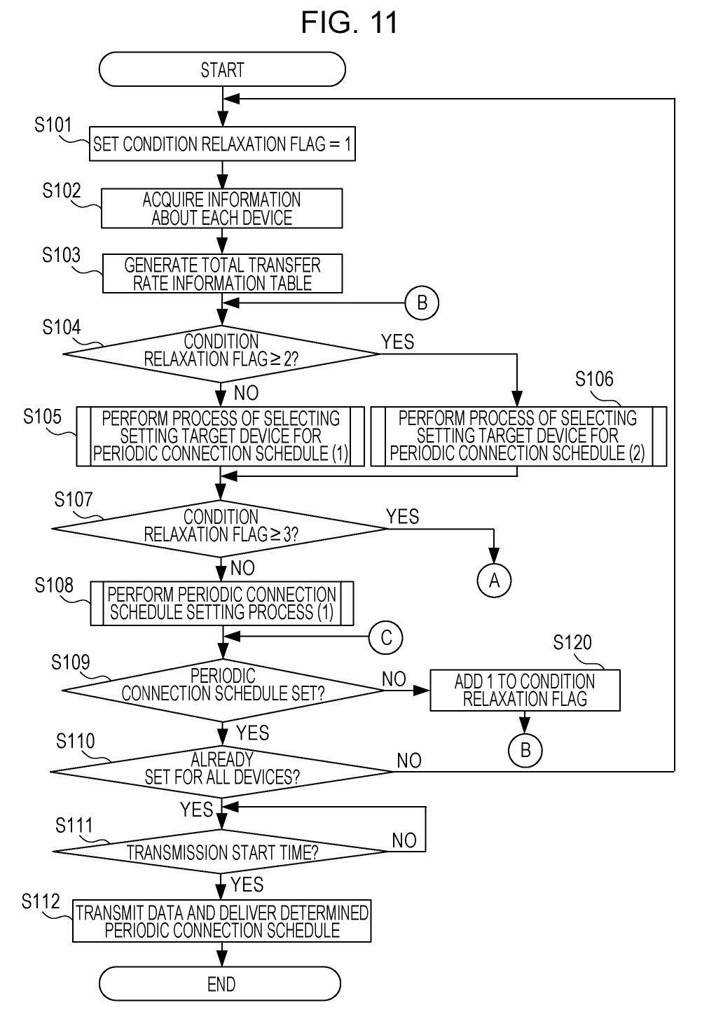

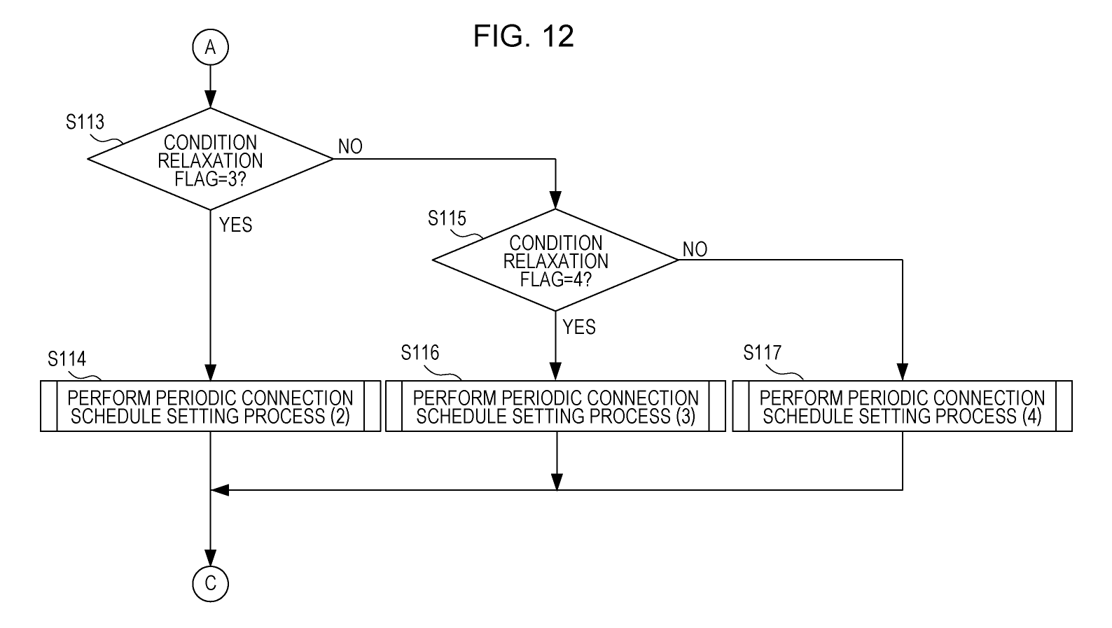

FIG. 11 and FIG. 12 are flowcharts illustrating an example of a process flow of the information processing apparatus 3. The process illustrated in FIG. 11 and FIG. 12 is executed, for example, a predetermined period prior to the data transmission start time of the information processing apparatus 3 indicated by the current periodic connection schedule. As described later, this is because the information processing apparatus 3 delivers the updated periodic connection schedule to the other information processing apparatuses 3 at the timing of periodic connection.

The first control unit 17 sets 1 as the initial value in a condition relaxation flag (operation S101). The acquisition unit 13 acquires various types of information from each monitored device (operation S102). The acquisition unit 13 acquires, for example, priority information, the size of data to be transmitted during periodic connection, the specified time zones of the periodic connection, and the transfer rate in each time zone from each monitored device.

The first control unit 17 generates the various tables described above based on the acquired priority information, size of data to be transmitted during the periodic connection, and specified time zones of the periodic connection and stores the generated tables in the first storage unit 12.

The generation unit 14 calculates the average of the acquired transfer rates of all the monitored devices so as to generate total transfer rate information indicating the values of averages of transfer rates of all the monitored devices (operation S103).

The selection unit 15 determines whether the condition relaxation flag is greater than or equal to 2 (operation S104). If the condition relaxation flag is less than 2 (No in operation S104), the selection unit 15 performs a process of selecting a setting target device for a periodic connection schedule (1) (operation S105). The condition relaxation flag is an integer from 1 to 5, and therefore the selection unit 15 performs the process of selecting a setting target device for a periodic connection schedule (1) when the condition relaxation flag is 1.

If the condition relaxation flag is greater than or equal to 2 (Yes in operation S104), the selection unit 15 performs a process of selecting a setting target device for a periodic connection schedule (2) (operation S106).

The setting unit 16 determines whether the condition relaxation flag is greater than or equal to 3 (operation S107). If the condition relaxation flag is less than 3, the setting unit 16 performs a periodic connection schedule setting process (1) (operation S108). Since the condition relaxation flag is an integer from 1 to 5, the setting unit 16 performs the periodic connection schedule setting process (1) when the condition relaxation flag is 1 or 2.

If the condition relaxation flag is greater than or equal to 3 (Yes in operation S107), the process proceeds through “A” and thereafter the setting unit 16 performs processing. The process after “A” will be described with reference to FIG. 12. If the condition relaxation flag is 3 (Yes in operation S113), the setting unit 16 performs a periodic connection schedule setting process (2) (operation S114).

If the condition relaxation flag is not 3 (No in operation S113), the setting unit 16 performs a periodic connection schedule setting process (3) (operation S116) if the condition relaxation flag is 4 (Yes in operation S115).

If the condition relaxation flag is not 4 (No in operation S115), the setting unit 16 performs a periodic connection schedule setting process (4) (operation S117). Since the condition relaxation flag is an integer from 1 to 5, the setting unit 16 performs the periodic connection schedule setting process (4) when the condition relaxation flag is 5.

After operation S114, S116, or S117, the process proceeds through “C” to operation S109. With reference to FIG. 11, the process after “C” will be described.

The first control unit 17 determines whether, in operation S108, S114, S116, or S117, the periodic connection schedule has been set for the monitored device that is the setting target (operation S109). If the periodic connection schedule is not set (No in operation S109), the first control unit 17 adds 1 to the condition relaxation flag (operation S120).

If Yes in operation S109, the first control unit 17 determines whether the periodic connection schedule has been set for all of the monitored devices (operation S110). If No in operation S110, the process returns to operation S101.

If Yes in operation S110, the first communication unit 11 determines, by referencing the set periodic connection schedule, whether it is time for its device to start data transmission (operation S111). If No in operation S111, the first communication unit 11 waits until the data transmission start time of its device.

If Yes in operation S111, the first communication unit 11 transmits data indicating the state of its device to the monitoring device 1 and also delivers the updated periodic connection schedule to the other monitored devices (operation S112). When an individual type of information, that is, the priority, the transmission data size during periodic connection, the specified time zones, or the transfer rates of the device of this first communication unit 11 is changed, the first communication unit 11 may transmit the information together with schedule information to the other monitored devices.

As described above, when the setting unit 16 has been unable to set a periodic connection schedule, the first control unit 17 increments the condition relaxation flag. As the condition relaxation flag increases, the information processing apparatus 3 performs processing under the relaxed conditions in the process of selecting a target device for which a periodic connection schedule is to be set and the process of setting a periodic connection schedule, which will be described later.

In addition, the first communication unit 11 transmits data indicating the state of its device to the monitoring device 1 and also transmits the updated periodic connection schedule to the other monitored devices. Due to the processes described later, the periodic connection schedule is set in periods where there is a small possibility that overlapping with the periods of other monitored devices will occur, and therefore it is possible to suppress the occurrence of a communication delay during transmission of the updated periodic connection schedule.

In the process illustrated in FIG. 12, when the periodic connection schedule is not set for a setting target device, the conditions are relaxed and a periodic connection schedule setting process is performed again. As a result, a periodic connection schedule is set for all of the monitored devices.

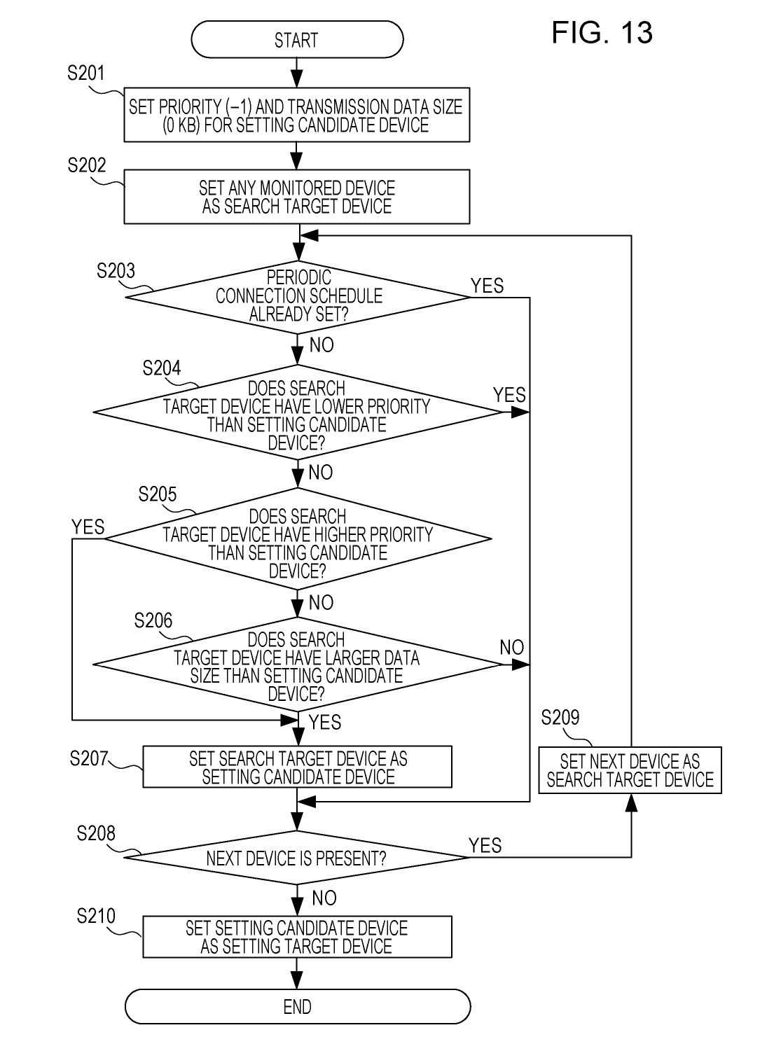

FIG. 13 is a flowchart illustrating an example of a process flow of operation S105 in FIG. 11. The selection unit 15 assigns areas for storing information regarding a setting candidate device used for selection processing described later to cache memory or the like. The selection unit 15 temporarily sets the priority (−1) and the size (0 KB) of data to be transmitted during periodic connection for the setting candidate device (operation S201).

The selection unit 15 sets any monitored device among a plurality of monitored devices as a search target device (operation S202). The selection unit 15 sets a monitored device indicated in the top row of a table that indicates the priority information of monitored devices (for example, FIG. 5) as the search target device.

The selection unit 15 determines, by referencing the periodic connection schedule, whether the period connection schedule has been set for the search target device (operation S203). If No in operation S203, it is determined whether the priority of the search target device is lower than the priority of the setting candidate device (operation S204).

If No in operation S204, it is determined whether the priority of the search target device is higher than the priority of the setting candidate device (operation S205). If Yes in operation S205, the selection unit 15 sets the search target device as a setting candidate device (operation S207).

If No in operation S205, the selection unit 15 determines whether the size of data to be transmitted by the search target device during periodic connection is larger than the size of data to be transmitted by the setting candidate device during periodic connection (operation S206).

If Yes in operation S206, the selection unit 15 sets the search target device as a setting candidate device (operation S207).

If Yes in operation S203, if Yes in operation S204, or if No in operation S206, the selection unit 15 determines whether the next device (a monitored device that has not yet been set as a search target device) is present (operation S208). If, for example, the search target device is indicated in a row other than the last row of the table that indicates the priority information of monitored devices (for example, FIG. 5), the selection unit 15 determines that the next device is present.

If No in operation S208, the setting candidate device is set as a target device for which a periodic connection schedule is to be set (operation S210).

If Yes in operation S208, the next device is set as a search target device (operation S209). The selection unit 15 sets, for example, a monitored device indicated in the row next to the row of the current search target device in the table that indicates the priority information of monitored devices (for example, FIG. 5) as a search target device.

By the process illustrated in FIG. 13, the selection unit 15 preferentially sets a device having the highest priority among a plurality of monitored devices as a target device for which a periodic connection schedule is to be set. Accordingly, even when there are a large number of monitored devices, overlapping between a monitored device having a high priority and another monitored device in a periodic connection schedule is suppressed.

In addition, the selection unit 15 preferentially selects a monitored device having the largest size of data to be transmitted during periodic connection among a plurality of monitored devices when the devices having the same priority are present. As the size of data increases, the transmission period of the data increases. Accordingly, overlapping between the transmission period of a monitored device and the transmission period of another monitored device is suppressed.

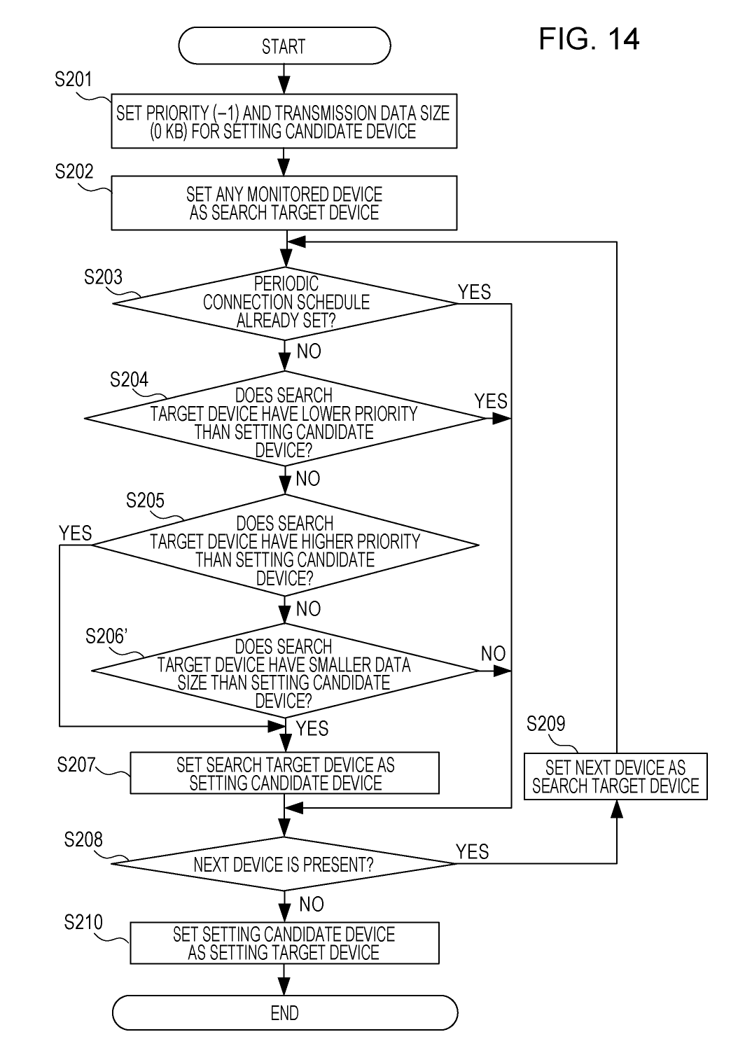

FIG. 14 is a flowchart illustrating an example of a process flow of operation S106 in FIG. 11. In the process illustrated in FIG. 14, operation S206′ is performed instead of operation S206 in the process illustrated in FIG. 13. In FIG. 14, the process other than operation S206′ is the same as in FIG. 13 and therefore description thereof is omitted.

The selection unit 15 determines whether the size of data to be transmitted during periodic connection by the search target device is smaller than the size of data to be transmitted during periodic connection by the setting candidate device (operation S206′). If Yes in operation S206′, the selection unit 15 sets the search target device as a setting candidate device (operation S207).

The process illustrated in FIG. 14 is a process that is performed when although the setting target device has been selected by the process in FIG. 13, there is no time in which a periodic connection schedule is able to be set and addition to the condition relaxation flag has been made in operation S113.

In the process illustrated in FIG. 14, the selection unit 15 preferentially selects a setting target device in which the size of data is smallest to be transmitted during periodic connection when the monitored devices have the same priority. Accordingly, the monitored device selected by the process in FIG. 14 has a higher possibility that a periodic connection schedule will be set than a monitored device selected by the process in FIG. 13.

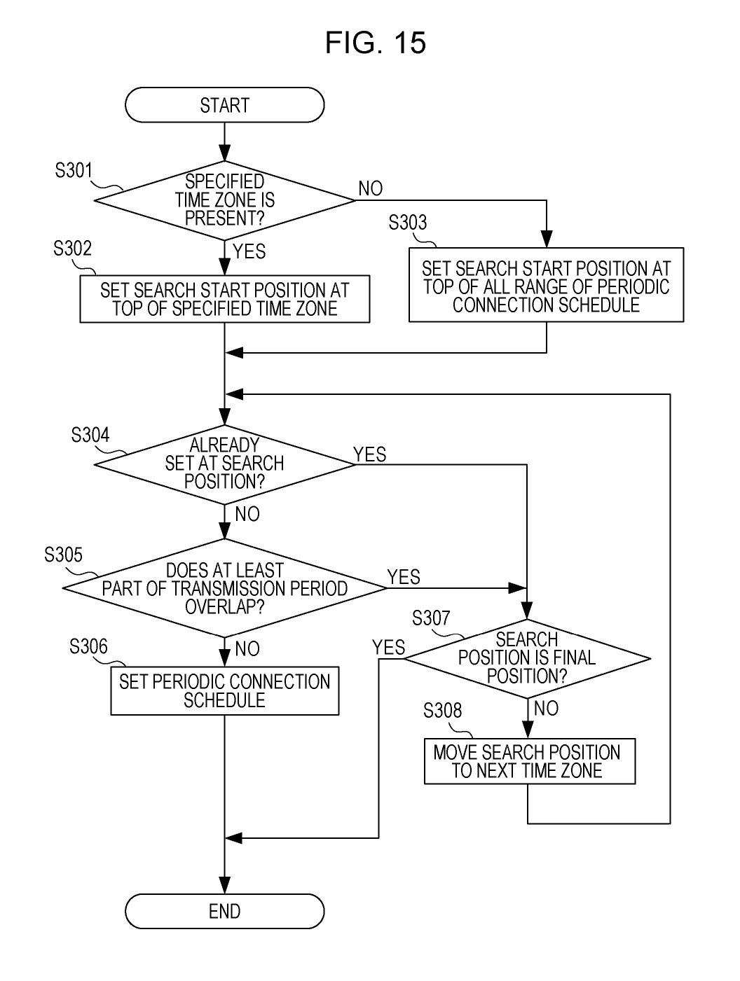

FIG. 15 is a flowchart illustrating an example of a process flow of operation S108 in FIG. 11. Note that the setting target device for a periodic connection schedule in the process illustrated in FIG. 15 is the monitored device selected in S105 or S106 in FIG. 11.

The setting unit 16 determines whether a specified time zone is present for the setting target device (operation S301). The setting unit 16 determines, for example, by referencing information indicating specified time zones of periodic connection for monitored devices stored in the first storage unit 12, whether a specified time zone associated with the setting target device is present.

If Yes in operation S301, the setting unit 16 sets the search start position in the periodic connection schedule (for example, FIG. 10) at the top position of the specified time zone (operation S302). For example, if the specified time zone is 9:00-17:00 on a weekday, the setting unit 16 sets 9:00 on Monday as the search start position.

If No in operation S301, the setting unit 16 sets the search start position at the top position of all the range of the periodic connection schedule (operation S303). For example, in operation S303, the setting unit 16 sets 00:00 on Monday as the search start position.

The setting unit 16 determines whether the periodic connection schedule of any monitored device is set at the search position (operation S304). For example, when a device name is recorded in the time zone indicated by a search position in the periodic connection schedule, the setting unit 16 determines that the periodic connection schedule is set.

If No in operation S304, the setting unit 16 determines whether when data is transmitted in such a manner that the time zone indicated by the search position is the transmission start position, at least part of the transmission period overlaps that of another monitored device (operation S305).

For example, the setting unit 16 calculates the time taken for transmission (transmission period) by dividing the size of data scheduled to be transmitted of the setting target device. Then, if the schedule has no vacant time from a time zone indicated by the search position to a time zone obtained by adding the time taken for transmission to the time zone, the setting unit 16 determines that the transmission period of its device overlaps the transmission period of another monitored device.

If No in operation S305, the setting unit 16 sets the periodic connection schedule such that the search position is the data transmission start time (operation S306). The setting unit 16 sets, for example, the device name of its device in a period from a time zone indicated by the search position to a time zone obtained by adding a transmission period to the time zone in the periodic connection schedule stored in the first storage unit 12.

If Yes in operation S304 or if Yes in operation S305, the setting unit 16 determines whether the search position is the final position of the periodic connection schedule (operation S307). In the example illustrated in FIG. 10, 23:59 on Sunday is the final position of the periodic connection schedule. If the search position is the final position (Yes in operation S307), the setting unit 16 terminates the setting process.

If the search position is not the final position (No in operation S307), the setting unit 16 moves the search position to the next time zone (operation S308) and performs the process in operation S304. For example, when the search position is 00:00 on Monday, the setting unit 16 moves the search position to 00:01 on Monday in operation S308.

In the process illustrated in FIG. 15, if a specified time zone is present (Yes in operation S301), the setting unit 16 sets the periodic connection schedule within the specified time zone, which enables the response by the administrator during failure occurrence to be made earlier.

In addition, if, in the periodic connection schedule, a period in which the transmission period of a monitored device other than the selected monitored device is not set is present (No in operation S304), the setting unit 16 sets the data transmission start time of the selected monitored device within the period. Accordingly, the information processing apparatus 3 may suppress the delay in communication caused by the increased network load.

In addition, if a period in which the transmission period of a monitored device other than the selected monitored device is not set and that is longer than or equal to the transmission period of data of the selected monitored device is present (No in operation S305), the setting unit 16 sets the data transmission period of the selected monitored device within the period. That is, the setting unit 16 sets the periodic connection schedule so that the transmission period of the selected monitored device does not overlap the transmission period of another monitored device. Accordingly, the information processing apparatus 3 may suppress the delay of communication due to congestion of the link.

For example, when a delay has occurred in periodic connection from a monitored device, there is a possibility that the monitoring device 1 might misunderstand that a communication failure has occurred. However, the information processing apparatus 3 in the embodiment suppresses the delay in communication and therefore may suppress the occurrence of misunderstanding.

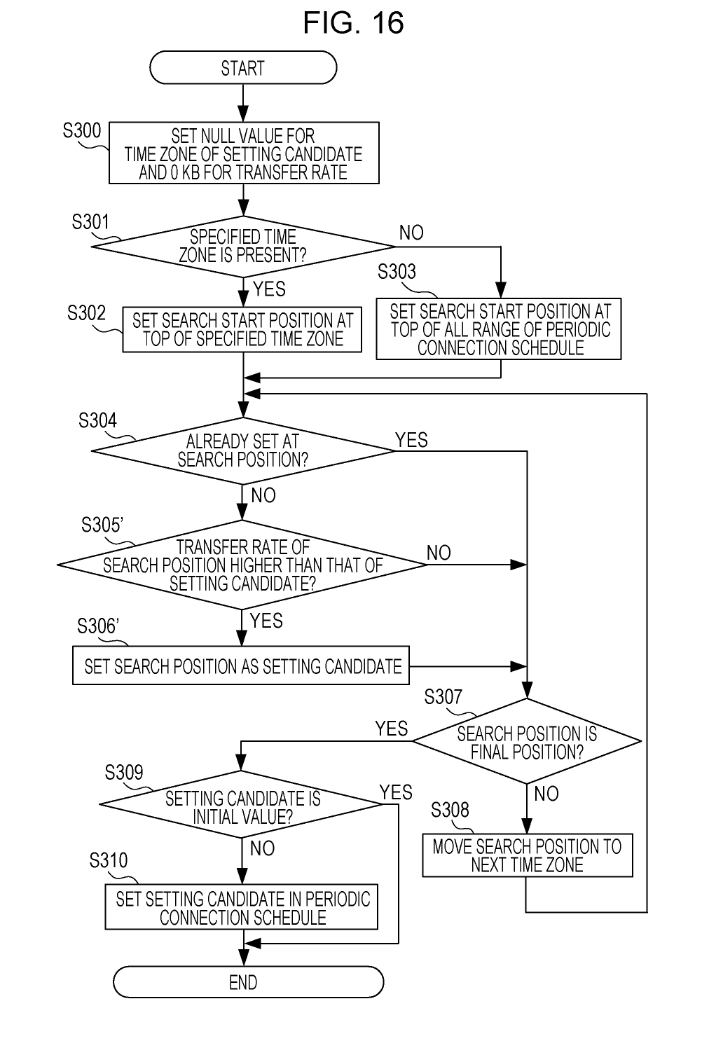

FIG. 16 is a flowchart illustrating an example of a process flow of operation S114 in FIG. 12. In the process illustrated in FIG. 16, operations S300, S309, and S310 are added to the process illustrated in FIG. 15 and operations S305′ and S306′ are included instead of operations S305 and S306. Therefore, for the process similar to that illustrated in FIG. 15, part of the description is omitted.

The setting unit 16 assigns the area in which information regarding a setting candidate used for setting processing described later is stored to cache memory or the like. The setting unit 16 sets “NULL” for the transmission start time and the transmission period of the setting candidate and sets “0 KB” for the transfer rate (operation S300).

The setting unit 16 determines whether a specified time zone is present for the setting target device (operation S301). If Yes in operation S301, the setting unit 16 sets the search start position in the periodic connection schedule at the top position of the specified time zone (operation S302). If No in operation S301, the setting unit 16 sets the search start position at the top position of all the range of the periodic connection schedule (operation S303).

The setting unit 16 determines whether the periodic connection schedule of any monitored device is set at the search position (operation S304).

The setting unit 16 determines whether the transfer rate of the time zone indicated by the search position is higher than the transfer rate of the set candidate (operation S305′). The setting unit 16, for example, acquires the transfer rate of the time zone indicated by the search position from the total transfer rate information. The setting unit 16, for example, may acquire the transfer rate of the time zone indicated by the search position from the transfer rates of the setting target device.

If Yes in operation S305′, the setting unit 16 sets the time zone indicated by the search position and the transfer rate of this time zone as a setting candidate (operation S306′).

If Yes in operation S304, if No in operation S305′, or after the process in operation S306′, the setting unit 16 determines whether the search position is the final position of the periodic connection schedule (operation S307).

If the search position is not the final position (No in operation S307), the setting unit 16 moves the search position to the next time zone (operation S308) and performs the process in operation S304.

If the search position is the final position (Yes in operation S307), the setting unit 16 determines whether the setting candidate is the initial value (the time zone being “NULL” and the transfer rate is “0 KB”). If the setting candidate is the initial value (Yes in operation S309), the setting unit 16 terminates the setting process.

If the setting candidate is not the initial value (No in operation S309), the setting unit 16 sets the time zone of the setting candidate in the periodic connection schedule (operation S310).

The process illustrated in FIG. 16 does not include operation S305 in FIG. 15 in which it is determined whether at least part of the transmission period overlaps that of another monitored device, and thus the setting conditions are relaxed. Therefore, even when at least part of the transmission period overlaps that of another monitored device, there is a possibility that the periodic connection schedule is set by the process illustrated in FIG. 16.

However, in the process of operations S304 to S308, the setting unit 16 sets a transmission period in a period having the highest transfer rate among periods for which the periodic connection schedule has not yet been set. Accordingly, by the process illustrated in FIG. 16, the delay in communication may be suppressed even when at least part of the transmission period of a monitored device overlaps the transmission period of another monitored device.

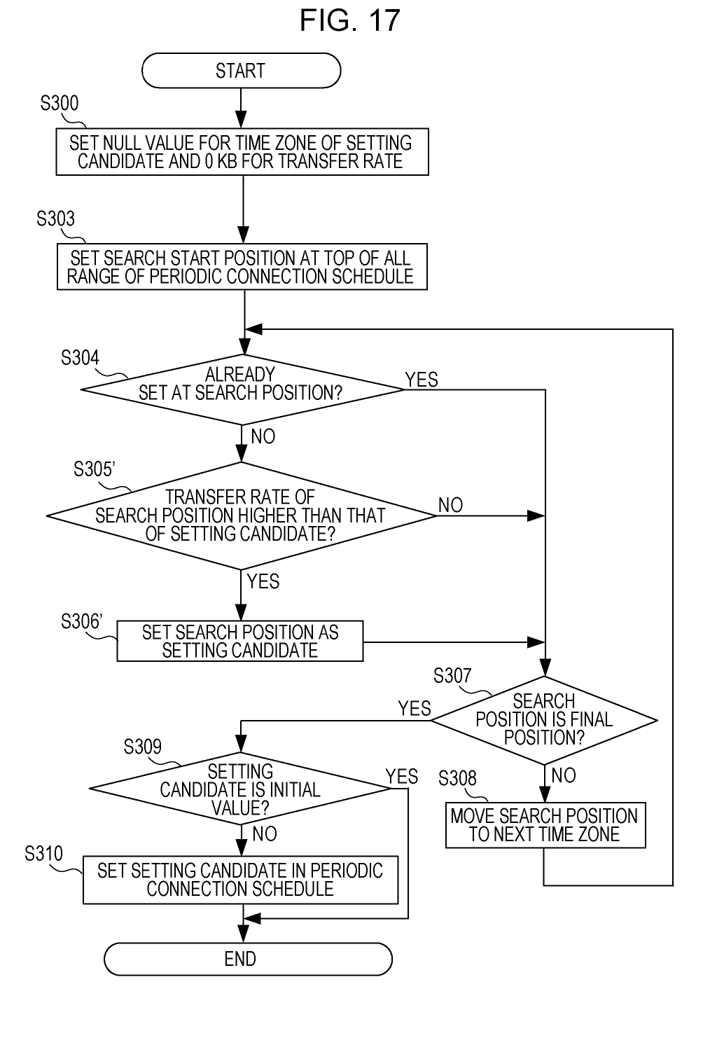

FIG. 17 is a flowchart illustrating an example of a process flow of operation S116 in FIG. 12. The process illustrated in FIG. 17 differs from the process illustrated in FIG. 16 in that operations S301 and S302 are absent. That is, in the process illustrated in FIG. 17, regardless of whether or not a specified time zone is present for the setting target device, the setting unit 16 sets the search start position at the top position of all the range of the periodic connection schedule (operation S303).

That is, in the process illustrated in FIG. 17, the setting unit 16 searches times other than the specified time zone of the setting target device for the periodic connection schedule, and therefore there is a high possibility of setting the periodic connection schedule for the setting target device, compared with the process illustrated in FIG. 16.

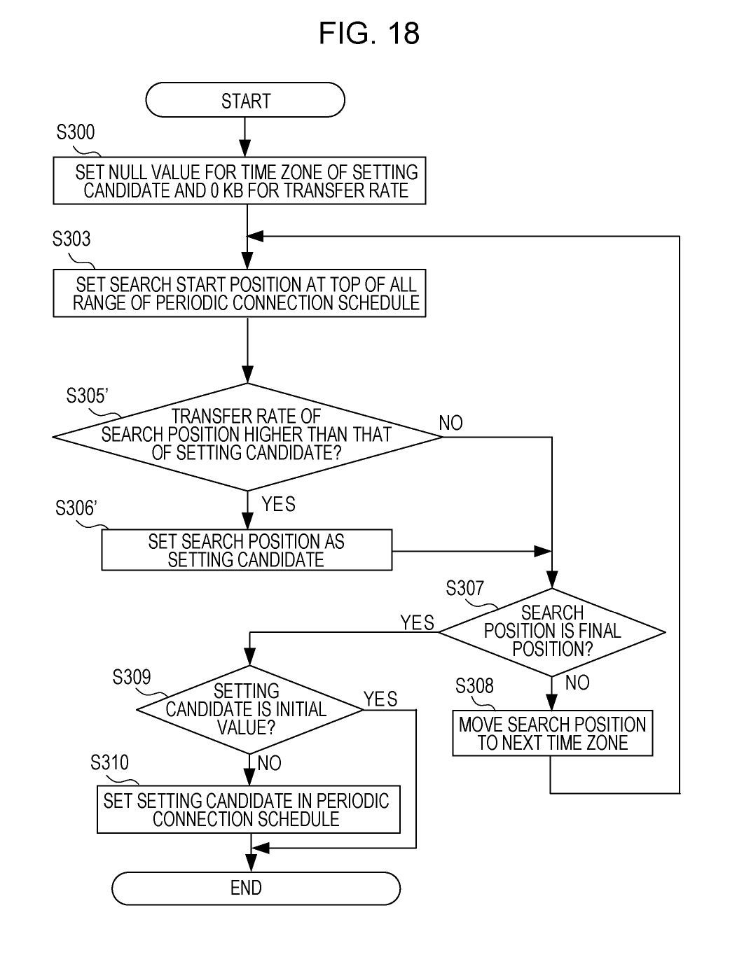

FIG. 18 is a flowchart illustrating an example of a process flow of operation S117 in FIG. 12. The process illustrated in FIG. 18 differs from the process illustrated in FIG. 17 in that operation S304 is absent. That is, in the process illustrated in FIG. 17, the setting unit 16 sets the periodic connection schedule even when the schedule of the search position is not open.

In the process illustrated in FIG. 18, there is a possibility that the transmission period of the setting target device overlaps the transmission period of another monitored device. However, the setting unit 16 sets the periodic connection schedule in a time zone with the highest transfer rate, and therefore the delay in communication may be suppressed.

In addition, in the processes illustrated in FIG. 15 to FIG. 17, since the process in operation S304 is present, there is a possibility that the periodic connection schedule will not be set if the determination result in operation S304 is not Yes. However, in the process illustrated in FIG. 18, since operation S304 is absent, the periodic connection schedule is set in any time zone for the setting target device.

As described above, since the information processing apparatus 3 automatically sets the periodic connection schedule of a plurality of monitored devices by using a plurality of conditions, the periodic connection schedule may be set easily and suitably even if the number of monitored devices is large. In addition, the information processing apparatus 3 may easily handle a change in the transmission data size of a monitored device and an increase or decrease in the number of devices.

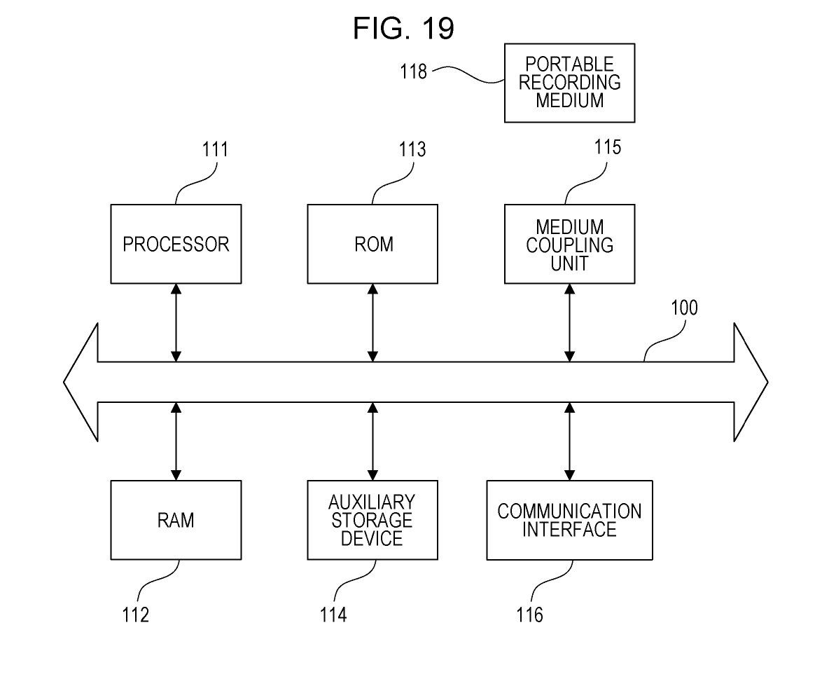

Next, with reference to the example in FIG. 19, an example of a hardware configuration of the information processing apparatus 3 and the electronic device 4 will be described. As illustrated in the example in FIG. 19, a processor 111, random access memory (RAM) 112, and read-only memory (ROM) 113 are coupled to a bus 100. In addition, an auxiliary storage device 114, a medium coupling unit 115, and a communication interface 116 are coupled to the bus 100.

The processor 111 executes programs loaded onto the RAM 112. As a program to be executed, an information processing program that performs processing in the embodiment may be applied.

The ROM 113 is a nonvolatile storage device that stores therein programs to be loaded onto the RAM 112. The auxiliary storage device 114 is a storage device that stores therein various types of information and, for example, a hard disk, semiconductor memory, or the like may be applied to the auxiliary storage device 114. The medium coupling unit 115 is provided to be able to be coupled to a portable recording medium 118.

Portable memory, an optical disc (for example, compact disc (CD) or a digital versatile disc (DVD)), semiconductor memory, or the like may be applied as the portable recording medium 118. On this portable recording medium 118, an information processing program that performs processes of the embodiment may be recorded.

The first storage unit 12 illustrated in FIG. 2 and the second storage unit 22 illustrated in FIG. 3 may be implemented by the RAM 112, the auxiliary storage device 114, and the like. The first communication unit 11 illustrated in FIG. 2 and the second communication unit 21 illustrated in FIG. 3 may be implemented by the communication interface 116. The acquisition unit 13, the generation unit 14, the selection unit 15, the setting unit 16, and the first control unit 17 illustrated in FIG. 2 may be implemented when the processor 111 executes a given information processing program.

The RAM 112, the ROM 113, the auxiliary storage device 114, and the portable recording medium 118 are all examples of a computer-readable tangible storage medium. These tangible storage media are not temporary media such as signal carrier waves

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus included in an information processing system including a monitoring device and a plurality of first devices that transmit data to the monitoring device in accordance with a schedule, at least one information processing apparatus being included in the plurality of first devices, the information processing apparatus comprising:
a memory; and
a processor coupled to the memory and the processor is configured to:
select a target device for which a schedule is to be set from among the plurality of first devices based on a priority of each of the plurality of first devices, the priority being acquired from other ones of the plurality of first devices, and
when, in the schedule, an unset period in which a transmission period for data transmission to the monitoring device is not set for one or more first devices other than the target device among the plurality of first devices is present, set a start time for the data transmission by the target device within the unset period.

2. The information processing apparatus according to claim 1,
wherein the processor is configured to set a start time for the data transmission for the target device based on a specified time zone of the data transmission set for the target device.

3. The information processing apparatus according to claim 1,
wherein the processor is configured to, when, in the schedule, a period that is an unset period in which the transmission period is not set for the one or more first devices other than the target device and that is greater than or equal to the transmission period of the data of the target device is present, set the transmission period of the target device within the period.

4. The information processing apparatus according to claim 1,
wherein the processor is configured to select a first device in which a size of the data is largest to be transmitted from among the plurality of first devices having the same priority.

5. The information processing apparatus according to claim 4,
wherein the processor is configured to, when there is no time in which a start time for the data transmission of the target device is able to be set, select a first device having a smallest size of the data to be transmitted from among the plurality of first devices having the same priority.

6. The information processing apparatus according to claim 1,
wherein the processor is configured to set a start time for the data transmission of the target device in a time zone with a highest transfer rate between the plurality of first device and the monitoring device.

7. The information processing apparatus according to claim 1,
wherein the processor is further configured to transmit an updated schedule of the plurality of first devices to first devices other than the target device among the plurality of first devices when transmitting the data to the monitoring device.

8. An information processing method performed by an information processing apparatus, the information processing method comprising:
selecting a target device for which a schedule is to be set from among a plurality of first devices based on a priority of each of the plurality of first devices, the priority being acquired from other ones of the plurality of first devices; and
when, in the schedule, an unset period in which a transmission period of data transmission to a monitoring device is not set for one or more first devices other than the target device among the plurality of first devices is present, set a start time for the data transmission by the target device within the unset period.

9. An information processing system comprising:
a monitoring device;
a plurality of devices monitored by the monitoring device, the plurality of devices periodically transmitting data to the monitoring device according to a schedule;
an information processing apparatus comprising;
a memory storing instructions; and
a processor coupled to the memory and configured to execute the instructions causing a process of:
setting one of the plurality of devices as a target device;
determining whether the schedule has been set for the target device;
determining, if a determination is made that the schedule has not been set, whether a priority of the target device is lower than a candidate device;
determining, if a determination is made that the priority of the target device is lower than that of the candidate device, whether the priority of the target device is higher than that of the candidate device;
determining, if a determination is made that the priority of the target device is not higher than that of candidate device, whether a data size of the target device is larger than that of the candidate device; and
setting the target device as the candidate device.

10. The information processing system according to claim 9,
wherein the processor is further configured to execute the instructions causing the process of determining whether the data size of the target device is smaller than that of the candidate device.

11. The information processing system according to claim 10,
wherein the processor is further configured to execute the instructions causing the process of setting the target device as the candidate device when a determination is made that the data size of the target device is smaller than that of the candidate device.

12. The information processing system according to claim 9,
wherein the processor is further configured to execute the instructions causing the process of determining whether a specified time zone is present for the target device.

13. The information processing system according to claim 12,
wherein the processor is further configured to execute the instructions causing the process of setting, when a determination is made that a specified time zone is present, a start position in the schedule.

14. The information processing system according to claim 13,
wherein the start position is a first position of the specified time zone.

15. The information processing system according to claim 12,
wherein the processor is further configured to execute the instructions causing the process of setting, when a determination is made that a specified time zone is not present, a start position in the schedule.

16. The information processing system according to claim 15,
wherein the start position is a first position of a time period.

17. The information processing system according to claim 13,
wherein the processor is further configured to execute the instructions causing the process of determining whether the start position overlaps with a transmission period of another one of the plurality of devices.

18. The information processing system according to claim 17,
wherein the determining whether the start position overlaps includes calculating the transmission period by dividing the data size of data of the target device to be transmitted.

19. The information processing system according to claim 18,
wherein the processor is further configured to execute the instructions causing the process of adding the transmission time to the specified time zone.
